(19) United States
(12) Patent Application Publication
(10) Pub. No.: US 2018/0222723 A1
(43) Pub. Date: Aug. 9, 2018

(54) ELEVATOR CAR

(71) Applicant: Otis Elevator Company, Farmington, CT (US)

(72) Inventors: Christele Gressien, Gien (FR); Frederic Beauchaud, Gien (FR); Emmanuel Convard, Gien (FR)

(21) Appl. No.: 15/742,312

(22) PCT Filed: Jul. 9, 2015
(86) PCT No.: PCT/EP2015/065711

§ 371 Date: Jan. 5, 2018

(51) Int. Cl. B66B 11/02

(52) U.S. Cl. CPC B66B 11/0246; B66B 11/008; B66B 11/0253

(57) ABSTRACT

An elevator car (12) for an elevator system (10) comprises: at least one side wall (38); at least one movable panel (60) forming at least a portion of the at least one side wall (38). The movable panel (60) is movable between a maintenance position, in which the panel allows access to components (28, 30, 32) of the elevator system (10), and an operational position, in which the movable panel (60) prevents access to said components (28, 30, 32). The at least one movable panel (60) comprises at least one handrail element (64), the handrail element (64) including a locking mechanism (54) which is configured to selectively lock the movable panel (60) in the operational position.

The present invention relates to an elevator car for an elevator system, in particular to an elevator car providing easy access to components of the elevator system.

An exemplary elevator system includes at least one elevator car moving along a hoistway. The elevator system further includes various system components, such as drive systems, electrical systems, a governor and tensioning device, a machine that drives the elevator car along the hoistway, and lighting systems that are typically located in the hoistway. Such components might be referred to as “hoistway-accessible components” or “hoistway-accessible systems”.

At least some of these components require periodic inspection, maintenance and/or repair. Such maintenance is typically performed by a technician entering the hoistway. Regulatory bodies have specified increases in safety volume and clearance for technicians entering the hoistway resulting in a larger overall volume of the elevator systems. Elevator system customers desire that the elevator system occupy a smaller overall volume. Thus, it is desired to perform maintenance and/or repair operations from other locations, such as from inside the elevator car.

It therefore would be beneficial to allow a technician to access the “hoistway-accessible” systems and components from inside the elevator car. At the same time passengers must be reliably prevented from accessing the “hoistway-accessible” systems and components.

An exemplary embodiment of an elevator car for an elevator system comprises at least one side wall and at least one movable panel forming at least a portion of said at least one side wall. The at least one movable panel is movable between a maintenance position and an operational position. When positioned in the maintenance position, the movable panel allows access to components or systems of the elevator system, in particular to “hoistway-accessible” components or systems. When positioned in the operational position, the movable panel prevents access to said components. The at least one movable panel comprises at least one handrail element. The handrail element includes a locking mechanism which is configured for selectively locking the panel in the operational position in order to prevent any movement into the maintenance position.

An exemplary embodiment of the invention further includes a method for providing access to a component of an elevator system from inside an elevator car, wherein the elevator car comprises: at least one side wall; and at least one movable panel forming at least a portion of the at least one side wall. The at least one movable panel is movable between at least one maintenance position, in which the panel allows access to components or systems of the elevator system, in particular to “hoistway-accessible” components or systems, and an operational position, in which the panel prevents access to said components, and the at least one movable panel comprises at least one handrail element, the handrail element including a locking mechanism, which is configured to selectively lock the panel in the operational position preventing any movement into the maintenance position. The method comprises the steps of unlocking the locking mechanism and moving the at least one movable panel from its operational position into one of its at least one maintenance positions.

Exemplary embodiments of the invention will be described in more detail with reference to the enclosed figures.

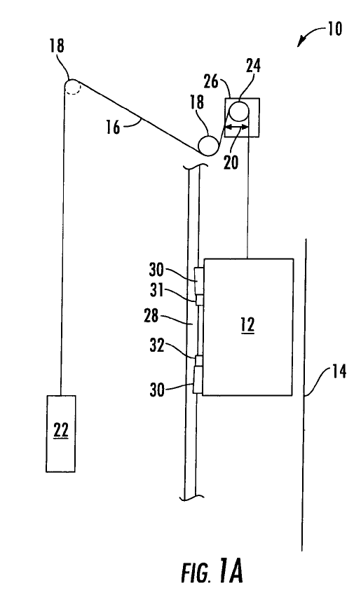

FIG. 1A is a schematic view of an exemplary elevator system having a 1:1 roping arrangement.

FIG. 1B is a schematic view of another exemplary elevator system having a different roping arrangement.

FIG. 1C is a schematic view of another exemplary elevator system having yet a another roping arrangement.

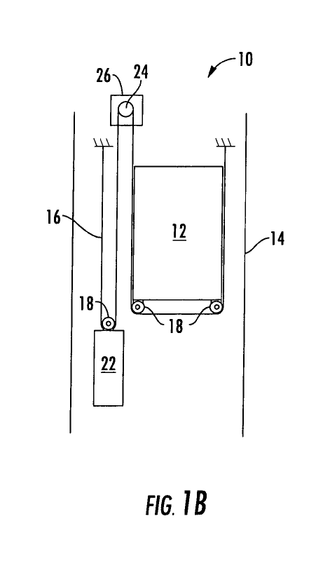

FIG. 2 is a schematic view of an exemplary embodiment of an elevator car including a translationally movable panel.

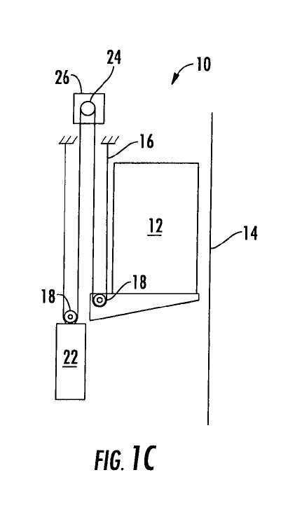

FIG. 3 is another schematic view of the exemplary embodiment shown in FIG. 2.

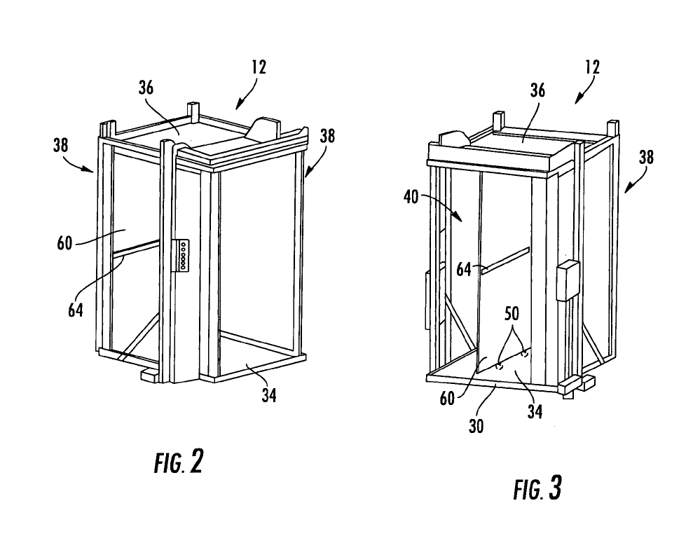

FIGS. 4a and 4b illustrate a configuration in which a side wall of the elevator car comprises a couple of panels including two translationally movable panels.

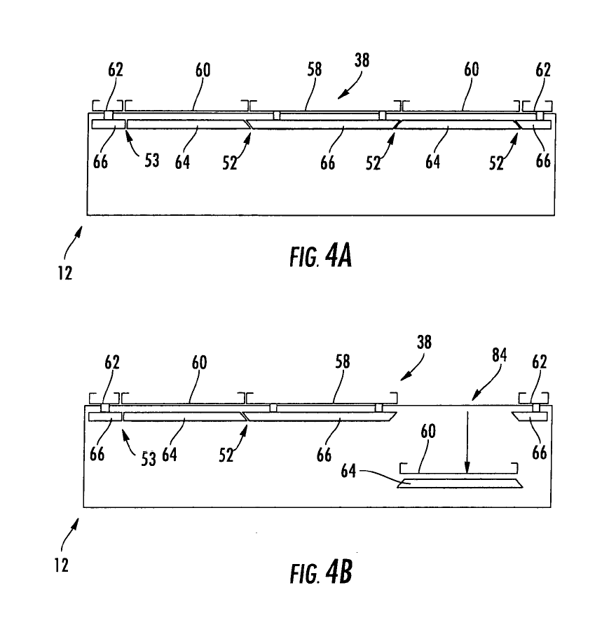

FIG. 5 is a schematic view of an embodiment comprising a scissor arm arrangement for moving the movable panel.

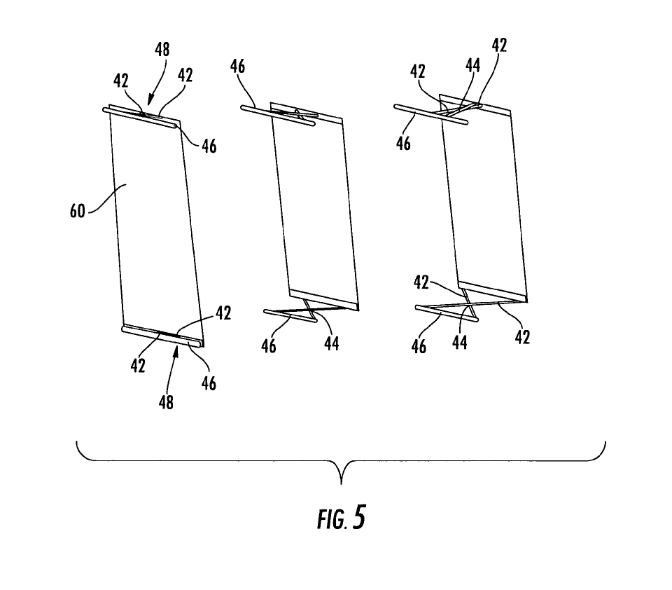

FIG. 6 shows an embodiment comprising a pivotable movable panel.

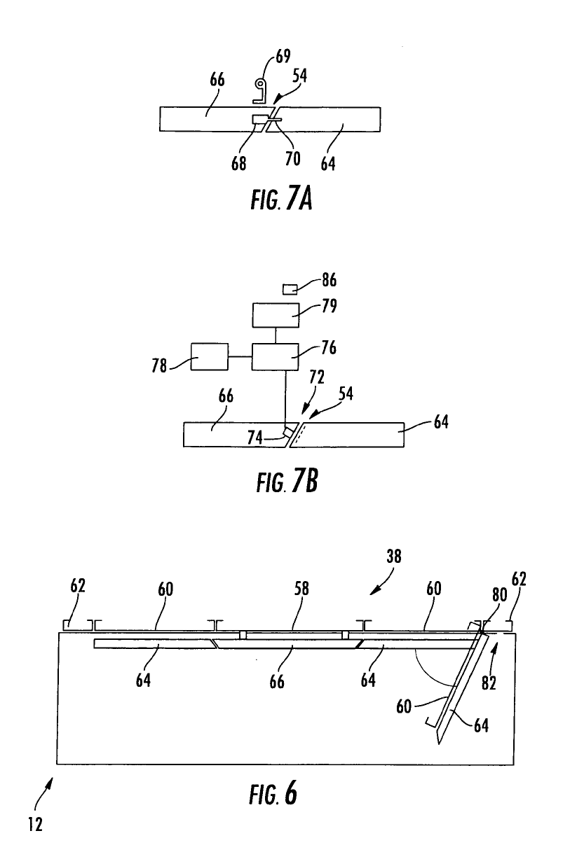

FIGS. 7a and 7b respectively show a schematic enlarged view of the interface between two adjacent handrail elements respectively including a locking mechanism.

Shown in FIGS. 1A, 1B and 1C are schematics of exemplary traction elevator systems 10. The elevator system 10 includes an elevator car 12 operatively suspended or supported in a hoistway 14 with one or more tension members 16, such as ropes or belts. In the configuration shown in FIGS. 1A, 1B, and 1C, the tension member 16 has the function of a suspension member carrying the load of the car 12.

The one or more tension members 16 interact with one or more sheaves 18, 24 to be routed around various components of the elevator system 10. The one or more sheaves 18, 24 could also be connected to a counterweight 22, which is used to help balance the elevator system 10 and reduce the difference in tension member 16 tension on both sides of a traction sheave 24 during operation. Then, the tension member 16 suspends both the car 12 and the counterweight 16.

The sheaves 18, 24 each have a diameter 20, which may be the same or different than the diameters of the other sheaves 18, 24 in the elevator system 10. At least one of the sheaves 18, 24 could be a traction sheave 24 configured to drive the car 12 and the counterweight 22 via the tension member 16. The traction sheave 24 is driven by a drive machine 26.

Movement of traction sheave 24 by the machine 26 drives, moves and/or propels (through traction) the one or more tension members 16 that are routed around the traction sheave 24.

At least one of the sheaves 18 could be a diverter, deflector or idler sheave. Diverter, deflector or idler sheaves are not driven by the machine 26, but help guiding the one or more tension members 16 around the various components of the elevator system 10.

While the embodiments are described in relation to elevator systems 10 with tension members 16, one skilled in the art will readily appreciate that the present disclosure may be applied to other types of elevator systems 19, such as those with self-propelled elevator cars 12 lacking tension members 16 suspending the elevator car 12 and/or counterweight 22.

Referring again to FIG. 1A, the elevator system 10 further includes one or more guide rails 28 to guide the elevator car 12 along the hoistway 14. The elevator car 12 includes one or more guide shoes 30 interactive with the guide rails 28 to guide the elevator car 12, and also may include safeties 32 interactive with the guide rail 28 to slow and/or stop motion of the elevator car 12 under certain conditions, such as an overspeed condition.

Referring now to FIGS. 2 and 3, an example of an elevator car 12 includes a floor 34, a ceiling 36 and a plurality of side walls 38. In order to allow insight into the interior of the elevator car 12, only two side walls 38 are shown in FIG. 2. The elevator car 12 further includes elevator doors (which are not shown in FIG. 2 for reasons of clarity) allowing ingress and egress of passengers at corresponding landing floors of the elevator system 10.

At least one of the side walls 38 comprises a movable panel 60, which is movable from an operational position, as it is shown in FIG. 2, to a maintenance position, as it is shown in FIG. 3. When the movable panel 60 is positioned in the maintenance position, a technician is able to access a maintenance area 40 of the elevator car 12, the maintenance area 40 being defined as the area between the movable panel 60 and an interior of the hoistway 14.

Said access to the maintenance area 40 allows the technician to perform inspection, maintenance and/or replacement of components in the hoistway 14 or at least accessible via the hoistway 14, such as a drive cabinet, an electrical cabinet, a lighting cabinet, a machine, a car and a counterweight buffer, a tension device, a governor, safeties 32, guide shoes 30, guide rails 28, tension members 16 and/or other components of the elevator system 10.

The maintenance can be performed from inside the elevator car 12, without the technician being forced to enter the hoistway 14 either, for example, above the elevator car 12 or below the elevator car 12.

When moving from its operational position to its maintenance position, the movable panel 60 translates linearly across the floor 34. In some embodiments the movable panel 60 abuts the opposite side wall 38 when in the maintenance position.

One or more rollers or wheels 50 are positioned between the bottom of the movable panel 60 and floor 34 for supporting the movable panel 60 during translation across the floor 34 and ease movement of the movable panel 60. The rollers or wheels 50 may be guided by guide rails (not shown) provided on the floor 34 in order to ensure that the movable panel 60 is transferred to a predetermined maintenance position within the elevator car 12.

To additionally ease movement of the movable panel 60 to the maintenance position, a biasing member, for example a spring, which is not shown in the figures may be provided for biasing the movable panel 60 toward the maintenance position.

The movable panel 60 is provided with a handrail element 64 which allows passengers to stabilize themselves within the elevator car 12 by grabbing the handrail element 64. The handrail element 64 additionally constitutes a handle providing a better grip for a technician when moving the movable panel 60. The handrail element 64 thus facilitates the movement of the movable panel 60 by the technician.

In the embodiment shown in FIGS. 2 and 3, the entire side wall 38 is moved for simplifying the illustration. It is, however, to be appreciated that the side wall 38 may be formed from a plurality of panels 58, 60, 62 with at least one of the panels 60 being movable.

FIGS. 4a and 4b show a schematic plane view of such a configuration comprising a plurality of panels 58, 60, 62. In the embodiment shown in FIGS. 4a and 4b, a side wall 38 of the elevator car 12 in particular comprises five panels 58, 60, 62, including a central fixed panel 58 and two movable panels 60 respectively positioned adjacent to both sides of the central panel 58. Outer fixed panels 62 are arranged next to each of the movable panels 60 opposite to the fixed central panel 58, respectively. As result, the central fixed panel 58 is sandwiched between two movable panels 60 and each of the movable panels 60 is sandwiched between the central panel 58 and one of the outer fixed panels 62, respectively.

In the configuration shown in FIG. 4a both movable panels 60 are positioned in their respective operational positions in between the fixed central panel 58 and one of the fixed outer panels 62. In FIG. 4b one of the movable panels 60 has been translationally moved from its operational position to a maintenance position providing an opening 84 in the side wall 38. Said opening 84 allows a mechanic to access systems and components 28, 30, 32 located outside the elevator car 12 from inside the elevator car 12.

FIGS. 4a and 4b further illustrate handrail elements 64, 66 respectively attached to each of the panels 58, 60, 62. A first type of handrail element 64 is attached to the movable panel 60, while a second type of handrail element 66 is attached to each of the fixed panels 58, 62, respectively.

Small gaps 52, 53 are formed between adjacent handrail elements 64, 66. In the configuration shown in FIGS. 4a and 4b a plurality of the gaps 52 are slanted with respect to the longitudinal direction of the handrail elements 64, 66, and also slanted with respect to the plane of the panels 58, 60, 62. However, in case of a translational movement of the movable panels 60, the gap 53 may be formed rectangularly with respect to the plane of the panels 58, 60, 62, as well.

FIG. 5 illustrates an exemplary embodiment, in which the motion of the movable panel 60 is controlled by means of a scissor mechanism 48. The scissor mechanism 48 includes a pair of scissor arms 42 located near the floor 34, and/or at the ceiling 36 of the elevator car 12. Each pair of scissor arms 42 is connected at a pivot 44. A first end of each scissor arm 42 is slidably connected to the movable panel 60, while an opposing second end of the scissor arm 42 is slidably connected to a portion 46 of a car frame.

When the movable panel 60 is moved from the operational position to the maintenance position by, for example, a pulling or pushing force applied by the technician, the scissor arms 42 rotate about the pivot 44 moving the arms' ends closer together to guide the motion of the movable panel 60 in a linear path. Likewise, when the movable panel 60 is moved from the maintenance position to the operational position, the scissor arms 42 are rotated about the pivot 44 in an opposite direction to again guide the linear motion of the movable panel 60.

FIG. 6 illustrates an alternative embodiment, in which the movable panel 60 is pivotable around a vertical axis 80 connecting the movable panel 60 to an adjacent fixed panel 62. In the embodiment shown in FIG. 6, a vertical axis 80 is provided at a fixed panel 62 arranged at a corner 82 of the elevator car 12; the vertical axis 80 of course similarily may be provided at the central fixed panel 58, as well.

FIGS. 7a and 7b respectively show an enlarged schematic view of the interface between two adjacent handrail elements 64, 66 respectively illustrating a locking mechanism 54 being configured for locking the movable panel 60 in its operational position.

FIG. 7a schematically illustrates a mechanical lock 68 provided in one of the handrail elements 66 comprising a movable pin 70, which is movable by means of a mechanical key 69 between a locked position, in which it is inserted into an opening provided in the opposing handrail element 64 for preventing any movement of the movable panel 60, and a retracted position (not shown) in which it is retracted from the opening for allowing the movable panel 60 to move with respect to the fixed panel 58, 62. It is appreciated that in an alternative but equivalent embodiment, the mechanical lock 68 may be located within the handrail element 64 of the movable panel 60 with the opening for receiving the pin 70 being provided within the handrail element 66 of a fixed panel 58, 62.

FIG. 7b schematically illustrates a electro-mechanical lock 72 comprising an electromagnet 74 allowing to lock and unlock the electro-mechanical lock 72 under the control of an electrical control unit 76. Again, the electromagnet 74 may be located equivalently in the within the handrail element 64 of a movable panel 60 or within the handrail element 66 of a fixed panel 58, 62.

In an embodiment the electro-mechanical lock 72 is configured such that the adjacent handrail elements 64, 66 are locked to each other when the electromagnet 74 is not energized, and the electro-mechanical lock 72 is unlocked by energizing the electromagnet 74.

Opening the electro-mechanical lock 72 may be triggered by entering a predetermined numerical or alphanumerical code via a keypad 78 connected to the electrical control unit 76, the keypad 78 in particular may be identical to the keypad 78 which is used for operating the elevator system 10. Alternatively or additionally, the opening of the electro-mechanical lock 72 may be triggered by placing an appropriate key-card 86 next to a corresponding key-card reader 79 provided at the elevator car 12.

In operation, the elevator system 10 is switched from normal, passenger conveying mode to a maintenance mode via, for example, a key switch in the elevator car 12, a key-card 86, or entering a maintenance access combination via a keypad 78.

When entering the maintenance mode, the elevator car 12 is driven to a predetermined location within the hoistway 14. In the following, the locking mechanism 54 is switched into an unlocked state and at least one movable panel 60 is moved from its operational position into its maintenance position in which it provides access to the maintenance area 40, as it has been described before.

The technician then may access the maintenance area 40 to perform inspection and/or maintenance operations. Once completed, the movable panel 60 is returned to its operational position and the elevator car 12 is driven to the next selected location for inspection and/or maintenance. Alternatively, the movable panel 60 may be kept in the maintenance position when the elevator car 12 is moved along the hoistway 14.

After all inspection and/or maintenance operations have been completed, the movable panel 60 is returned into its operational position and the locking mechanism 54 is locked again in order to bring the elevator system 10 back into its normal mode for passenger conveyance.

Locking the locking mechanism 54 prevents passengers from unauthorized access to the maintenance area 40. Integrating the locking mechanism 54 into the handrail elements 64, 66 provides a strong locking mechanism 54 without the need for introducing additional parts and/or reinforcing the movable panels 60.

### FURTHER EMBODIMENTS

Embodiments disclosed herein allow a technician to easily access the systems and components from inside the elevator car by unlocking the locking mechanism and moving the movable panel form the operational position to the maintenance position. Any unauthorized access to the systems and components is reliably prevented by locking the movable panel in its operational position. Integrating the locking mechanism into the handrail elements results in a strong locking mechanism without the need for introducing additional parts and/or reinforcing the movable panel(s).

A number of optional features are set out in the following. These features may be realized in particular embodiments, alone or in combination with any of the other features.

In an embodiment the elevator car may comprise a plurality of panels including the at least one movable panel and at least one fixed panel next to the movable panel, wherein the at least one fixed panel comprises a further handrail element and the locking mechanism is configured to lock the at least one handrail element of the movable panel with the further handrail element of the fixed panel. Providing a fixed panel next to the movable panel allows a secure fastening of the movable panel in its operational position.

In an embodiment the interface between the at least one handrail element of the movable panel and the handrail element of the fixed panel may be slanted with respect to a longitudinal direction of the handrail elements. This allows a pivoting motion between two adjacent panels. A slanted interface further provides a stop for abutting the movable element in the operational position.

In an embodiment the locking mechanism may comprise a mechanical lock. A mechanical lock provides a cheap and reliable locking mechanism and may be operated without providing any electrical energy.

In an embodiment the locking mechanism may comprise an electromagnetic lock. An electromagnetic lock provides a convenient locking mechanism allowing to apply more sophisticated unlocking algorithms than a mechanical lock.

The elevator system in particular may comprise a control unit, which is configured to open the electromagnetic lock when a predetermined code is entered via a numerical control panel and/or an electromagnetic key-card is located next to a key-card reader provided in the elevator car on order to reliably prevent unauthorized access to the maintenance area. For safety reasons, unlocking of the locking mechanism may be blocked as long as the elevator car is moving.

In an embodiment the elevator car may be configured to move within a hoistway of the elevator system. The movable panel, when position in the maintenance position, may provide access to the hoistway from inside the elevator car allowing easy, safe and convenient maintenance and/or repair of elements located within the hoistway.

In an embodiment the at least one movable panel may be pivotable between the operational position and the maintenance position. A pivotable motion of the movable panel around an axis provided inside the elevator car is easy to implement at low costs.

In an embodiment the at least one movable panel may be linearly movable between the operational position and the maintenance position. Linear translation of the movable panel allows a movement of the movable panel without a need for considering space for handrail elements or other components in the interior of the elevator car as it is necessary in the case of a hinged or rotational movement of the movable panel. An interior design of the elevator car with, for example, full panel mirrors, handrail elements, kickplates, etc., does not need to be modified to accommodate a translationally movable side wall.

In an embodiment the elevator car may comprise a scissor mechanism which is configured for guiding the at least one movable panel between the operational position and the maintenance position.

In an embodiment the elevator car may comprise at least one roller or wheel, which is configured for supporting the at least one movable panel in order to facilitate the movement of the movable panel.

In an embodiment the elevator car may comprise at least one guiding means, in particular a guide rail, which is configured for guiding the at least one roller or wheel in order to direct the movement of the movable panel. This facilitates to reliable position the movable element selectively either in the operational position or in a predetermined maintenance position.

In an embodiment the step of unlocking the locking mechanism may include using a mechanical key or an electromagnetic key-card, in particular placing a key-card next to a key-card reader.

In an embodiment the step of unlocking the locking mechanism may include entering a code via a keypad. This allows for unlocking the locking mechanism without the need for a physical key. The keypad may be an external keypad or part of a control panel provided inside the elevator car.

Unlocking the locking mechanism may also require both, providing a mechanical or electrical key and entering a code in order to reduce the risk of an unauthorized unlocking of the locking mechanism even further.

While the invention has been described with reference to exemplary embodiments, it will be understood by those skilled in the art that various changes may be made and equivalents may be substituted for elements thereof without departing from the scope of the invention. In addition many modifications may be made to adopt a particular situation or material to the teachings of the invention without departing from the essential scope of the invention. Therefore, it is intended that the invention not be limited to the particular embodiment disclosed, but that the invention include all embodiments falling within the scope of the dependent claims.

### REFERENCES

10 elevator system
12 elevator car
14 hoistway
16 tension member
18 sheaves
22 counterweight
24 traction sheave
26 machine
28 guide rails
30 guide shoes
32 safeties
34 floor
36 ceiling
38 side walls
40 maintenance area
42 scissor arm
44 pivot
46 portion of a car frame
48 scissor mechanism
50 rollers/wheels
52 slanted gap
53 rectangular gap
54 locking mechanism
58 central fixed panel
60 movable panel
62 outer fixed panel
64 handrail element of the movable panel
66 handrail element of the fixed panel
68 mechanical lock
69 mechanical key
70 movable pin
72 electro-mechanical lock
74 electromagnet
76 control unit
78 keypad
79 key-card reader
80 vertical axis
82 corner of the car
84 opening
86 key-card

1. An elevator car (12) for an elevator system (10) comprising:
at least one side wall (38);
at least one movable panel (60) forming at least a portion of the at least one side wall (38);
wherein the at least one movable panel (60) is movable between a maintenance position, in which the movable panel (60) allows access to components (28, 30, 32) of the elevator system (10), and an operational position, in which the movable panel (60) prevents access to said components (28, 30, 32),
wherein the at least one movable panel (60) comprises at least one handrail element (64), the handrail element (64) including a locking mechanism (54) which is configured to selectively lock the movable panel (60) in the operational position.

2. The elevator car (12) of claim 1, further comprising a plurality of panels (58, 60, 62) including the movable panel (60) and at least one fixed panel (58, 62) next to the movable panel (60), wherein the at least one fixed panel (58, 62) comprises a further handrail element (66) and the locking mechanism (54) is configured to lock the at least one handrail element (64) of the movable panel (60) with the further handrail element (66) of the fixed panel (58, 62).

3. The elevator car (12) of claim 1, wherein an interface (82) between the at least one handrail element (64) of the movable panel (60) and the further handrail element (66) of the fixed panel (58, 62) is slanted with respect to a longitudinal direction of the handrail elements (64, 66).

4. The elevator car (12) of claim 1, wherein the locking mechanism (54) comprises a mechanical lock (68).

5. The elevator car (12) of claim 1, wherein the locking mechanism (54) comprises an electromagnetic lock (72).

6. The elevator car (12) of claim 5, further comprising a control unit (74), which is configured to open the electromagnetic lock (72) when a predetermined code is entered via a numerical control panel (76) and/or an appropriate electromagnetic key-card (86) is located next to a key-card reader (78) provided in the elevator car (12).

7. The elevator car (12) of claim 1, wherein the elevator car (12) is configured to move within a hoistway (14) of the elevator system (10), and the movable panel (60), when positioned in the maintenance position, provides access to the hoistway (14) from inside the elevator car (12).

8. The elevator car (12) of claim 1, wherein the at least one movable panel (60) is pivotable between the operational position and the maintenance position.

9. The elevator car (12) of claim 1, wherein the at least one movable panel (60) is linearly movable between the operational position and the maintenance position.

10. The elevator car (12) of claim 1, comprising a scissor mechanism (48) which is configured for guiding the at least one movable panel (60) between the operational position and the maintenance position.

11. The elevator car (12) of claim 1, comprising at least one roller or wheel (50) which is configured for supporting the at least one movable panel (60).

12. The elevator car (12) of claim 11, comprising at least one guiding means, in particular a guide rail, which is configured for guiding the at least one roller or wheel (50).

13. Method for providing access to a component of an elevator system (10) from inside an elevator car (12), the elevator car (12) comprising:
at least one side wall (38);
at least one movable panel (60) forming at least a portion of the at least one side wall (38);
wherein at least one movable panel (60) is movable between at least one maintenance position, in which the movable panel (60) allows access to components (28, 30, 32) of the elevator system (10), and an operational position, in which the movable panel (60) prevents access to said components (28, 30, 32),
wherein the at least one movable panel (60) comprises at least one handrail element (64), the handrail element (64) including a locking mechanism (54), which is configured to selectively lock the movable panel (60) in the operational position;
the method comprising the steps of unlocking the locking mechanism (54) and moving the at least one movable panel (60) from its operational position into one of its at least one maintenance positions.

14. Method of claim 13, wherein the step of unlocking the locking mechanism (54) includes entering a code via an external key-pad (78) or via the elevator operating panel.

15. Method of claim 13, wherein the step of unlocking the locking mechanism includes using a mechanical key (69) or placing a key-card (86) next to a key-card reader (79).
